(19) United States
(12) Patent Application Publication
(10) Pub. No.: US 2010/0297284 A1
(43) Pub. Date: Nov. 25, 2010

(54) CASTING MOLD DEVICE

(75) Inventors: Kiyoshi Shibata, Tokyo (JP); Toshirou Ichihara, Tokyo (JP); Keizou Tanoue, Tokyo (JP); Yuuichi Honda, Tokyo (JP); Masamitsu Yamashita, Tokyo (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/679,396

(22) PCT Filed: Sep. 11, 2008
(86) PCT No.: PCT/JP2008/002518

§ 371 Date: May 15, 2010

(30) Foreign Application Priority Data
Sep. 21, 2007 (JP) 2007-244996

(51) Int. Cl. B29C 39/44

(52) U.S. Cl. 425/468

(57) ABSTRACT

A metal mold device for casting that is adapted to prevent a casting sleeve from falling and that keeps even spacing between an inner circumferential wall of the casting sleeve and an outer circumferential wall of a bore pin. Ball plungers are provided at regular intervals in a circumferential direction on an outer circumferential portion of the bore pin in the vicinity of a distal end of the bore pin and on an outer circumferential portion in the vicinity of a basal end thereof, respectively, with respect to the axial direction of the bore pin. Three distal ball plungers are provided on the outer circumferential portion in the vicinity of the distal end of the bore pin and three basal ball plungers are provided on the outer circumferential portion in the vicinity of the basal end thereof. The distal ball plungers are 60° out of phase with the basal ball plungers when viewed in the axial direction. Further, the distal ball plungers are provided in an area where a piston ring, in the vicinity of a top dead center position of a piston, is located.

### FIELD OF THE INVENTION

The present invention relates to a metal mold device for casting an engine block, a cylinder barrel and the like.

### BACKGROUND ART

When casting the engine block, the cylinder barrel and the like, a sleeve is cast in an inner circumferential wall of a cylinder. To cast the sleeve, the casting metal mold device is provided with a bore pin as disclosed in Japanese patent laid-open publication No. H06-71405. and carries out casting such that the sleeve is fitted on an outer circumference of the bore pin.

In the case where the bore pin extends in the downward or obliquely downward direction, the sleeve falls. Therefore, in Japanese patent laid-open publication No. 2004-74252, a support pin is provided together with the bore pin in the metal mold. When clamping the mold, the support pin is projected such that the support pin supports the lower end of the sleeve.

FIG. 4 is a cross sectional view in an axial direction showing the condition wherein the sleeve is held on the bore pin of the prior art, and FIG. 5 is a cross sectional view in a radial direction showing the condition wherein the sleeve is held on the bore pin of the prior art. When fitting the sleeve on the bore pin, it is necessary to make an inside diameter of the sleeve slightly larger than an outside diameter of the bore pin.

Consequently, the sleeve slips off the bore pin, so that an unequal thickness is created with respect to a thickness of the sleeve when carrying out the internal machining after casting, thereby affecting strain and stress at the time of driving an engine.

Further, in the device having the support pin for preventing the sleeve from falling as disclosed in Japanese patent laid-open publication No. 2004-74252, there is also a problem that an improper operation is generated due to the penetration of molten metal into a support pin insertion hole.

### SUMMARY OF THE INVENTION

In order to solve the above-mentioned problems in the prior art, a casting metal mold device in accordance with the present invention includes a sleeve, a bore pin for supporting the sleeve, and at least three ball plungers that are in elastic contact with an inner circumferential wall of the sleeve. The at least three ball plungers are provided at regular intervals in a circumferential direction on an outer circumference of the bore pin.

Since at least three plungers are provided at regular intervals in the circumferential direction, it is possible to reliably keep an even spacing between the inner circumferential wall of the sleeve and the outer circumferential wall of the bore pin.

In further accordance with the present invention, the plungers are provided in an area where a piston ring, in the vicinity of a top dead center position of a piston, is located. The plungers are preferably provided in this area because this area exerts the greatest influence upon the sliding movement of the piston.

According to the casting metal mold device of the present invention, the sleeve is prevented from falling. Also, it is possible to keep the even space between the inner circumferential wall of the sleeve and the outer circumferential wall of the bore pin, whereby no unequal thickness is created when machining the internal wall of the sleeve.

### BRIEF DESCRIPTION OF THE DRAWINGS

FIG. 1 is a cross sectional view of an essential part of a casting metal mold device according to the present invention, wherein (a) shows the condition before clamping a mold, and (b) is the condition after clamping the mold;

FIG. 2 is a cross sectional view in an axial direction showing the condition wherein a sleeve is held on a bore pin of the present invention;

FIG. 3 is a cross sectional view in a radial direction showing the condition wherein the sleeve is held on the bore pin of the present invention;

FIG. 4 is a cross sectional view in an axial direction showing the condition wherein the sleeve is held on the bore pin of the prior art; and

FIG. 5 is a cross sectional view in a radial direction showing the condition wherein the sleeve is held on the bore pin of the prior art.

### DETAILED DESCRIPTION OF THE PREFERRED EMBODIMENTS

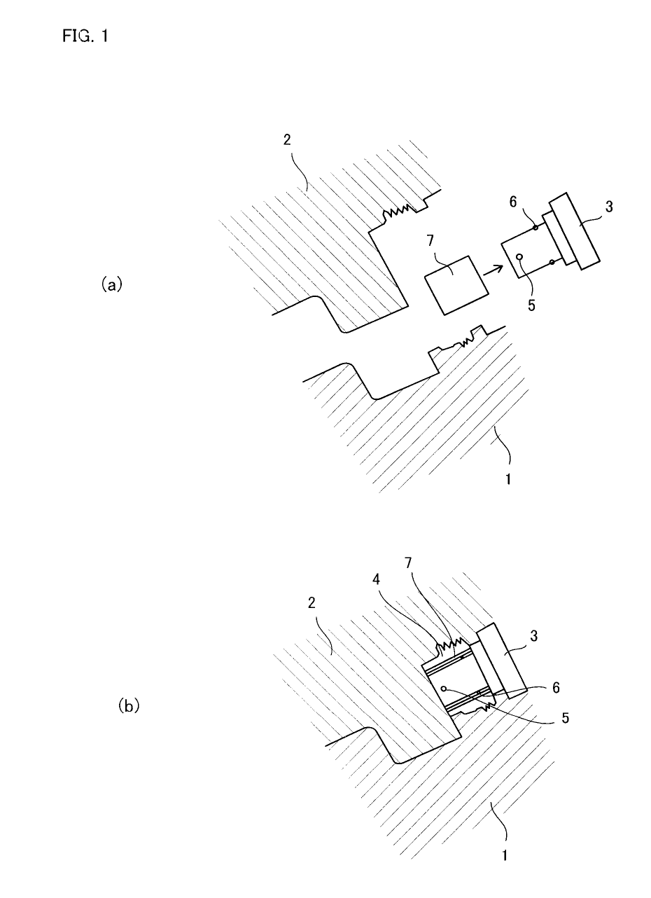

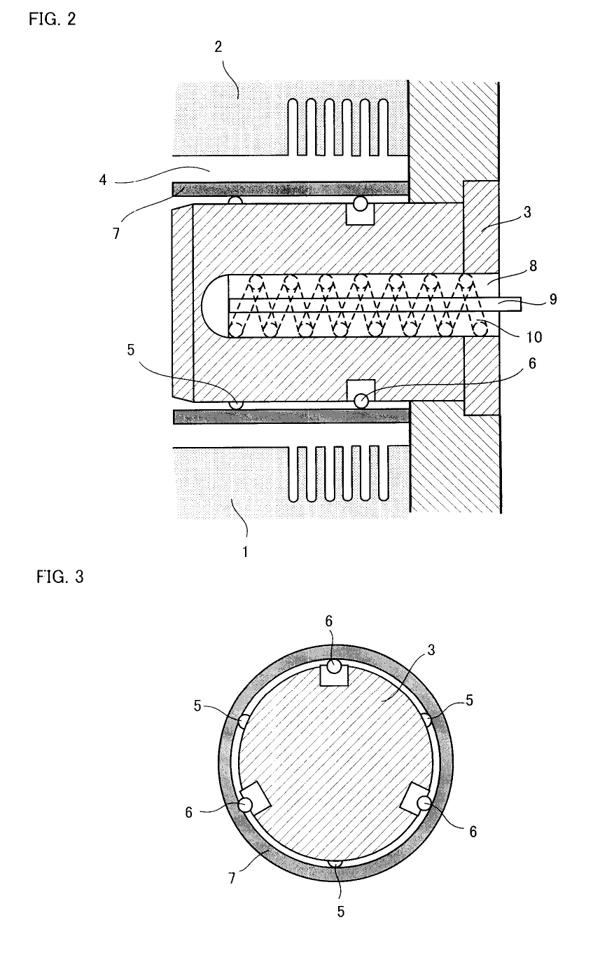

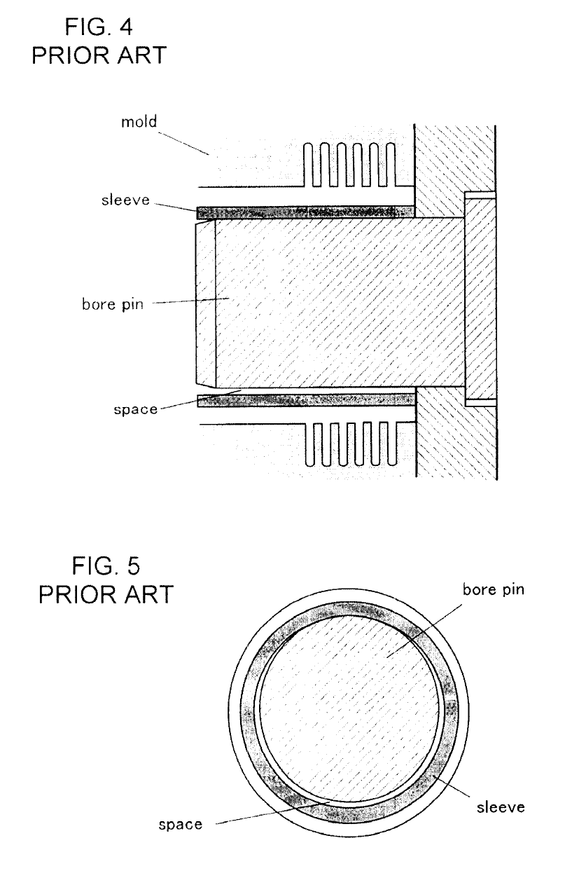

Embodiments of the present invention will be described hereunder with reference to the accompanying drawings. FIG. 1 is a cross sectional view of an essential part of a metal mold device for casting according to the present invention, wherein (a) shows the condition before clamping a mold, and (b) shows the condition after clamping the mold. FIG. 2 is a cross sectional view in an axial direction showing the condition wherein a sleeve is held on a bore pin. FIG. 3 is a cross sectional view in a radial direction showing the condition wherein the sleeve is held on the bore pin.

With reference to FIGS. 1-3, the casting metal mold device is provided with a fixed die 1, a movable die 2 and a bore pin 3. The bore pin 3 is inserted into and removed from a cavity 4 formed between the fixed die 1 and the movable die 2.

Ball plungers 5 and 6 are provided on the bore pin 3 at regular intervals in a circumferential direction of the bore pin 3. More specifically, ball plungers 5, 6 are provided on an outer circumferential portion of the bore pin in the vicinity of a distal end of the bore pin 3 and on an outer circumferential portion in the vicinity of a basal end thereof, respectively, with respect to the axial direction of the bore pin 3. In the illustrated embodiment, three distal ball plungers 5 are provided on the outer circumferential portion in the vicinity of the distal end of the bore pin 3 and three basal ball plungers 6 are provided on the outer circumferential portion in the vicinity of the basal end thereof. The distal ball plungers 5 are 60° (sixty degrees) out of phase with the three basal ball plungers 5 when viewed in the axial direction. Further, the distal ball plungers 6 are provided in an area where a piston ring in the vicinity of a top dead center of a piston is located.

Like this, the ball plungers are provided three each at a distal and basal location and each set of the plungers are phase shifted are shifted relative to the other set of ball plungers so that a sleeve 7 is able to be held stably. By the way, the form of the sleeve 7 is optional. For example, the sleeve may be obtained by a casting method.

Further, the bore pin defines a hole 8 extending from a back wall side thereof, into which a pipe 9 is inserted. The pipe 9 serves to supply a coolant into the interior of the bore pin 3 via the hole 8. Moreover, in order to efficiently carry out the heat exchange, a spiral groove 10 is formed on an inner circumferential wall of the hole 8, thereby increasing the interior exposed wall surface of the bore pin surrounding the hole 8.

With the above construction, the sleeve 7 is fitted onto the bore pin 3 in the condition before clamping the mold as shown in FIG. 1(a), so that the sleeve 7 is held by the elastic contact force of the plungers 5 and 6. Next, the mold is clamped as shown in FIG. 1(b) and molten metal is fed into the cavity 4.

1. A metal mold device for casting comprising a sleeve and a bore pin for holding said sleeve, wherein at least three ball plungers that are in elastic contact with an inner circumferential wall of said sleeve are provided at regular intervals in a circumferential direction on an outer circumference of said bore pin, wherein said bore pin has a hole into which a pipe is inserted to supply a coolant from a back wall side of said bore pin, and wherein a spiral groove is formed on an inner circumferential wall of said hole.

2. A metal mold device for casting according to claim 1, wherein said ball plungers are provided on the outer circumference of said bore pin in a vicinity of a distal end of said bore pin and on the outer circumference of said bore pin in an area where a piston ring in the vicinity of a top dead center of a piston is located, and wherein said ball plungers provided on the outer circumference in the vicinity of the distal end of said bore pin are 60° out of phase with said ball plungers provided on the outer circumference in the area where said piston ring in the vicinity of the top dead center of the piston is located, when viewed in the axial direction.
